(19) United States
(12) Patent Application Publication
(10) Pub. No.: US 2021/0329026 A1
(43) Pub. Date: Oct. 21, 2021

(54) RECONSTRUCTING MISSING COMPLEX NETWORKS AGAINST ADVERSARIAL INTERVENTIONS

(71) Applicant: UNIVERSITY OF SOUTHERN CALIFORNIA, Los Angeles, CA (US)

(72) Inventors: Paul Bogdan, Los Angeles, CA (US); Yuankun Xue, Los Angeles, CA (US)

(21) Appl. No.: 17/227,966

(22) Filed: Apr. 12, 2021

Related U.S. Application Data
(60) Provisional application No. 63/010,414, filed on Apr. 15, 2020.

(51) Int. Cl. H04L 29/06; H04L 12/24; G06N 7/00

(52) U.S. Cl. CPC H04L 63/1441; H04L 41/145; G06N 7/005; H04L 41/147; H04L 63/1425; H04L 41/0866

(57) ABSTRACT

Methods, systems, devices and apparatuses for reconstructing a network. The network reconstruction system includes a processor. The processor is configured to determine an unknown sub-network of a network. The unknown sub-network includes multiple unknown nodes and multiple unknown links. The processor is configured to determine the unknown sub-network based on a known sub-network that has multiple known nodes and multiple known links, a network model and an attacker's statistical behavior to reconstruct the network. The processor is configured to determine one or more network parameters of the network. The network processor is configured to provide a probability of an outcome of an input or observation into the network or into a second network that has the one or more network parameters of the network.

### CROSS-REFERENCE TO RELATED APPLICATION

This application claims priority to and the benefit of U.S. Provisional Patent Application No. 63/010,414 titled “RECONSTRUCTING MISSING COMPLEX NETWORKS AGAINST ADVERSARIAL INTERVENTIONS,” filed on Apr. 15, 2020, and the entirety of which is hereby incorporated by reference herein.

### STATEMENT REGARDING GOVERNMENT RIGHTS

This invention was made with Government support under Government Contract Nos. N66001-17-1-4044 awarded by the Defense Advanced Research Projects Agency (DARPA) and 1453860 awarded by the National Science Foundation (NSF). The Government has certain rights in this invention.

### BACKGROUND

### 1. Field

This specification relates to a system, apparatus and/or method for modeling, constructing and/or generating a large complex network based on a given limited observed network.

### 2. Description of the Related Art

Interactions within complex network components define their operational modes, collective behaviors and global functionality. Understanding the role of these interactions is limited by either sensing methodologies or intentional adversarial efforts that sabotage the network structure. It is crucial to discover the best identification and recovery strategies for sabotaged networks subject to unknown structural interventions or camouflages. This problem draws interdisciplinary attention in various areas and technological fields ranging from network science, social science, system engineering to ecology, systems biology, network medicine, neuroscience, and network security communities. Current works do not necessarily incorporate the statistical influence of these various interventions. Generally, prior works assume that structural interventions entail a sequence of randomly distributed removals of nodes and links, which represent the relationships and events of the associated network, and so, the construction of an unbiased estimation for the nodal or edge property is possible, but when the nodes and edges are simultaneously removed, the conventional approaches prove to be mathematically infeasible. Existing approaches require additional information that links the known and unknown portions of the network (e.g., group membership and node similarity) to determine the unknown parts of a network and are unfeasible or obsolete when such information is not available.

Other approaches may use a model-based approach that learns a probabilistic connection between the observed and the latent network structure. These probabilistic links may be parameterized and identified in a maximum likelihood sense. These approaches may be unified within an Expectation-Maximization (EM) framework that solves the model identification and inference problems simultaneously through an iterative trial-and-error approach with a provable convergence to the local maxima of the incomplete likelihood function. However, in the context of the missing network inference subject to artificially (not randomly) introduced interventions, the latent structure does not share the identical distribution as the observed one, but follows a reshaped distribution. This invalidates the use of EM formulations based on the assumption of random network removals, which does not change the underlying distribution.

Accordingly, there is a need for a method, system, apparatus and/or device for a causal statistical inference framework that jointly encodes the influence of probabilistic correlation between the known and unknown parts of the network and the stochastic behavior of the intervention.

### SUMMARY

In general, one aspect of the subject matter described in this specification is embodied in a device, a system and/or an apparatus for a network reconstruction system. The network reconstruction system includes a processor. The processor is configured to determine an unknown sub-network of a network. The unknown sub-network includes multiple unknown nodes and multiple unknown links. The processor is configured to determine the unknown sub-network based on a known sub-network that has multiple known nodes and multiple known links, a network model and an attacker's statistical behavior to reconstruct the network. The processor is configured to determine one or more network parameters of the network. The network processor is configured to provide a probability of an outcome of an input or observation into the network or into a second network that has the one or more network parameters of the network.

These and other embodiments may optionally include one or more of the following features. The processor may be configured to determine, predict or model the attacker's statistical behavior using a causal statistical inference framework. The network model may be a multi-fractal network generative model that models a variety of network types with prescribed statistical properties including a degree distribution and has unknown parameters. The network reconstruction system may include one or more sensors or an external database. The one or more sensors may be configured to obtain or detect known data. The external database may be configured to store and provide the known data. The processor may be configured to obtain, from the one or more sensors or the external database, the known data. The processor may be configured to construct the known sub-network of the network including the multiple known nodes and the multiple known links based on the known data.

The known data may be obtained over multiple different periods of time and the unknown sub-network may change over the multiple different periods of time. The network may be related to a social network, a biological or physiological network or a computer network. The multiple known nodes may represent events within the social network, the biological or physiological network or the computer network. The multiple known links may represent a relationship among the events within the social network, the biological or physiological network or the computer network.

The one or more network parameters may include at least one of a network connectivity of the network, a probability of the network connectivity of the network, relationships between nodes of the network including any impacts one node has on another node, or constraints of the network. The network reconstruction system may include a memory. The memory may be configured to store known data or the known sub-network of the network. The known sub-network may have multiple known nodes ad multiple known links. The network reconstruction system may include a display. The display may be configured to output the probability of the outcome. The processor may be coupled to the memory and the display. The processor may be configured to obtain, from the memory, the known data or the known sub-network of the network. The processor may be configured to render on the display the probability of the outcome.

The processor may be configured to determine a causal inference of the unknown sub-network using the network model that captures properties of the network to determine the unknown sub-network of the network. The processor may be configured to construct a series of maximization steps over an incomplete likelihood function based on the network model and one or more parameters. The processor may be configured to iteratively maximize a log-likelihood function at each step within the series of maximization steps using a Monte-Carlo sampling procedure where the one or more parameters change until a current result of the log-likelihood function at a current step converges with a previous result of the log-likelihood function at a previous step. The processor may be configured to compare a difference between the current result and the previous result with a tolerance. The current result may converge with the previous result when the difference is less than or equal to the tolerance.

In another aspect, the subject matter is embodied in a method for network reconstruction. The method includes determining, by a processor, an unknown sub-network of a network including multiple unknown nodes and multiple links based on a known sub-network, a network model and an attacker's statistical behavior to reconstruct the network. The known sub-network has multiple nodes and multiple links. The method includes determining, by the processor, one or more network parameters of the network. The method includes providing, by the processor, a probability of an outcome of an input into the network or into a second network that has the one or more network parameters of the network.

In another aspect, the subject matter is embodied in a non-transitory computer-readable medium including computer readable instructions, which when executed by a processor, cause the processor to perform operations. The operations include determining an unknown sub-network of a network including multiple unknown nodes and multiple unknown links based on a known sub-network of the network having multiple known nodes and multiple known links, a network model and an attacker's statistical behavior to reconstruct the network. The operations include determining one or more network parameters of the network and displaying a probability of an outcome of an input into the network or into a second network that has the one or more network parameters of the network.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views.

FIG. 1 is a diagram of an example network reconstruction system according to an aspect of the invention.

FIG. 2 is a flow diagram for generating and utilizing a reconstructed network using the network reconstruction system of FIG. 1 according to an aspect of the invention.

FIG. 3 is a flow diagram for reconstructing the unknown sub-network of the network using the network reconstruction system of FIG. 1 according to an aspect of the invention.

FIG. 4 shows an example graphical representation of the network model and adversarial intervention behavior using the network reconstruction system of FIG. 1 according to an aspect of the invention.

FIG. 5A shows an example graphical representation of the estimation error of a quantification of the capability of inferring synthetic networks under varying attack strategies using the network reconstruction system of FIG. 1 as a function of the missing network under hub-prioritized intervention according to an aspect of the invention.

FIG. 5B shows an example graphical representation of the estimation error of a quantification of the capability of inferring synthetic networks under varying attack strategies using the network reconstruction system of FIG. 1 as a function of the missing network under boundary-prioritized intervention according to an aspect of the invention.

FIG. 5C shows an example graphical representation of the Kullback-Leibler (KL) divergence comparison of the true linking probability distribution with the presence of hub-prioritized intervention to quantify the capability of inferring synthetic networks under varying attack strategies using the network reconstruction system of FIG. 1 according to an aspect of the invention.

FIG. 5D shows an example graphical representation of the KL divergence comparison of the true linking probability distribution with the presence of boundary-prioritized intervention to quantify the capability of inferring synthetic networks under varying attack strategies using the network reconstruction system of FIG. 1 according to an aspect of the invention.

FIG. 6A shows an example graphical representation of a reshaped degree distribution of the latent network structure of the network model using the network reconstruction system of FIG. 1 according to an aspect of the invention.

FIG. 6B shows an example graphical representation of the capability of the network reconstruction system of FIG. 1 to reconstruct the missing network structure under hub-prioritized intervention according to an aspect of the invention.

FIG. 6C shows an example graphical representation of the capability of the network reconstruction system of FIG. 1 to reconstruct the missing network structure under boundary-prioritized intervention according to an aspect of the invention.

FIG. 7A shows example graphical representation of the recovery of a human protein complex interaction network represented by the ROC-AUC score and using the network reconstruction system of FIG. 1 according to an aspect of the invention.

FIG. 7B shows an example graphical representation of the recovery of a human protein complex interaction network represented by a goodness-of-the fit comparison using the Kolmogrov-Smirnov (KS) distance and using the network reconstruction system of FIG. 1 according to an aspect of the invention.

FIG. 7C shows an example graphical representation of the recovery of a human protein complex interaction network represented by the PR-AUC score and using the network reconstruction system of FIG. 1 according to an aspect of the invention.

FIG. 7D shows an example graphical representation of the recovery of a human protein complex interaction network represented by the log-likelihood function and using the network reconstruction system of FIG. 1 according to an aspect of the invention.

FIG. 7E shows an example graphical representation of the recovery of a human protein complex interaction network and brain consensus connectome represented by the ROC-AUC score and using the network reconstruction system of FIG. 1 according to an aspect of the invention.

FIG. 7F shows an example graphical representation of the recovery of a human protein complex interaction network and brain consensus connectome represented by a goodness-of-the fit comparison using the Kolmogrov-Smirnov (KS) distance and using the network reconstruction system of FIG. 1 according to an aspect of the invention.

FIG. 7G shows an example graphical representation of the recovery of a human protein complex interaction network and brain consensus connectome represented by the log-likelihood function and using the network reconstruction system of FIG. 1 according to an aspect of the invention.

FIG. 7H shows an example graphical representation of the recovery of a human protein complex interaction network and brain consensus connectome represented by the log-likelihood function and using the network reconstruction system of FIG. 1 according to an aspect of the invention.

FIG. 8 shows an example graphical representation of the coverage of a social network with nodes that have been manipulated according to an aspect of the invention.

FIG. 9A shows an example graphical representation of the recovery of a social network represented by the ROC-AUC score and using the network reconstruction system of FIG. 1 according to an aspect of the invention.

FIG. 9B shows an example graphical representation of the recovery of a social network represented by a goodness-of-the fit comparison using the Kolmogrov-Smirnov (KS) distance and using the network reconstruction system of FIG. 1 according to an aspect of the invention.

FIG. 9C shows an example graphical representation of the recovery of a social network represented by the PR-AUC score and using the network reconstruction system of FIG. 1 according to an aspect of the invention.

FIG. 9D shows an example graphical representation of the recovery of a social network represented by the log-likelihood function and using the network reconstruction system of FIG. 1 according to an aspect of the invention.

FIG. 10 shows an example graphical representation of a comparison of the capability to estimate the number of affected users of a social network using the network reconstruction system of FIG. 1 according to an aspect of the invention.

FIG. 11A shows an example graphical representation of an inference of runtime as a function of missing nodes with a network of size 4049 using the network reconstruction system of FIG. 1 according to an aspect of the invention.

FIG. 11B shows an example graphical representation of an inference of runtime as a function of missing nodes with a network of size 1015 using the network reconstruction system of FIG. 1 according to an aspect of the invention.

### DETAILED DESCRIPTION

Disclosed herein are systems, apparatuses, devices and methods for a network model reconstruction system (or “network reconstruction system”). A network reconstruction system may reconstruct or construct other invisible (or unknown) parts of the network. The network reconstruction system may use the visible (or known) parts of the network to interpolate, extrapolate or otherwise formulate the invisible parts of the network. The network reconstruction system infers the missing nodes and links of the invisible parts of the network from the visible parts of the network. For example, the network reconstruction system understands or determines the relationships between the events including inputs and outputs at each and in between each of the nodes in the visible parts of the network and may infer and/or probabilistically determine with the greatest likelihood the subsequent structure of the invisible parts of the network.

Other benefits and advantages include that the network reconstruction system may jointly encode the influence of probabilistic correlation between the visible and invisible parts of the network. The network reconstruction system may use a causal statistical inference framework, which may capture the temporal causality of sequenced attacks and threats to the partially observed network as a result of time inhomogeneous Markovian transitions that are driven by the interventions. This allows the network reconstruction system to apply to any underlying network models that are appropriate to the specific problem settings. For example, the network reconstruction system may be employed with a multi-fractal network generative model (MFNG) as the underlying network model because it can model a variety of network types with prescribed statistical properties (e.g. degree distribution). And thus, the network reconstruction may be applied to real networks in various domains including the biological and social domains.

Additionally, the causal inference framework considers the statistical behavior of intervention and its causal influence on reshaping the underlying distribution of the latent structure through a sequence of dynamic attack strategies. The application is effective in various domains including different sets of real complex networks, such as social-, genomic-, and neuro-science. The framework helps explore a wide spectrum of real complex network problems. For instance, instead of assuming the intervention model a priori, the network reconstruction system considers a range of intervention policies and postulated network scales (e.g., network size) to infer the unknown or missing sub-network under different scenarios. The different scenarios allow for rediscovery of the unknown sub-network in a variety of networked systems that are subject to variations and limited observabilities.

For example, in biological systems, the prevalence of structural robustness against random removal may reflect some degree of evolutionary wisdom because it offers a protection against internal or external random perturbations and mutations. However, adversarial entities, such as viruses and cancer cells, develop counter-strategies to cancel out these structural advantages to maximize their own survival benefits. This notion also applies to social, computer, and traffic networks where infrequent yet highly connected hubs actually dominate the normal operation of entire system. The are consequently much more easily targeted and, one sabotaged, give rise to greater social, political, and economic expenses. Real threats and interventions are therefore rarely randomized and in an inference framework that admits widely ranged structural interventions is a must.

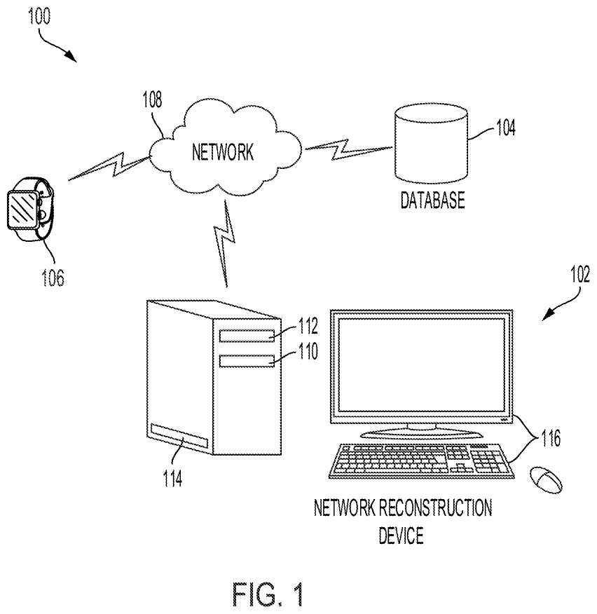

FIG. 1 shows a diagram of the network reconstruction system 100. The network reconstruction system 100 implements both a model inference and a model identification simultaneously to identify or determine the unknown nodes and links of an unknown sub-network of a network and reconstruct the network in its entirety. The network may be related to a social network, a biological or physiological network, a computer network or other network. Each node within the network may represent an event within the network and each link may represent a relationship among or between two or more events within the network. The network reconstruction system 100 may also determine one or more network parameters of the network so that the network reconstruction system 100 may determine the outcome, consequences or changes of the network or similar network given an input or observation of the network or other network, such as an adversarial intervention within the network or the other network with similar network parameters as the network.

The network reconstruction system 100 includes a network reconstruction device 102, a database 104 and/or one or more sensors 106. The network reconstruction system may include a network 108. The various components of the network reconstruction system 100 may be coupled to or integrated with one another by the network 108. The network 108 may be a wired or a wireless connection, such as a local area network (LAN), a wide area network (WAN), a cellular network, a digital short-range communication (DSRC), the Internet, or a combination thereof, which the different components.

The network reconstruction system 100 may include a database 104. A database is any collection of pieces of information that is organized for search and retrieval, such as by a computer, and the database 104 may be organized in tables, schemas, queries, report, or any other data structures. A database may use any number of database management systems. A database 104 may include a third-party server or website that stores or provides information. The information may include real-time information, periodically updated information, or user-inputted information. The information may include known data, such as data or information related to the network, which may be used to construct a known sub-network of the network including the known nodes and/or known links and/or the network parameters of the network. In some implementations, the information may include the actual known sub-network of the network and/or the entire network including the known nodes and known links of the network.

The network reconstruction system 100 includes a network reconstruction device 102. The network reconstruction device 102 includes a processor 110, a memory 112, a network access device 114 and/or a user interface 116. The processor 110 may be a single processor or multiple processors. The processor 110 may be electrically coupled to some or all of the components of the network reconstruction device 102. The processor 110 may be coupled to the memory 112. The processor 110 may obtain known data or a known sub-network of the network and use the known data or the known sub-network of the network to interpolate, extrapolate and/or infer the unknown data or the unknown sub-network of the network. Once the network is formed, the processor 110 may determine or predict a probability of an outcome or consequence of an adversarial intervention and/or determine or predict a probability of an outcome or consequence of a given input or observation. The processor 110 may be used to alert the operator or a user of the probability or likelihood of the outcome or consequence and/or other aspect of the network, such as one or more network parameters.

The memory 112 is coupled to the processor 110. The memory 112 may store instructions to execute on the processor 110. The memory 112 may include one or more of a Random Access Memory (RAM) or other volatile or non-volatile memory. The memory 112 may be a non-transitory memory or a data storage device, such as a hard disk drive, a solid-state disk drive, a hybrid disk drive, or other appropriate data storage, and may further store machine-readable instructions, which may be loaded and executed by the processor 110. The memory 112 may store the known data, the known sub-network, the network model, the generated or formed completed network and/or the one or more network parameters of the network.

The network reconstruction device 102 may include a network access device 114. The network access device 114 may be used to couple the various components of the network reconstruction system 100 via the network 108. The network access device 114 may include a communication port or channel, such as one or more of a Wi-Fi unit, a Bluetooth® unit, a Radio Frequency Identification (RFID) tag or reader, a DSRC unit, or a cellular network unit for accessing a cellular network (such as 3G, 4G or 5G). The network access device 114 may transmit data to and receive data from the various components.

The network reconstruction device 102 may include a user interface 116. The user interface 116 may be part of the network reconstruction device 102 and may include an input device that receives user input from a user interface element, a button, a dial, a microphone, a keyboard, or a touch screen. The user interface 116 may include a touch-screen display or other interface for a user to provide user input to indicate locations of stopping events, home events, terrain events or one or more other charging events. Moreover, the user interface 116 may provide an output device, such as a display, a speaker, an audio and/or visual indicator, or a refreshable braille display. The user interface 116 may provide the output device, such as a display, any notifications, warnings or alerts and/or provide a visual representation of the network and/or provide the probability of an outcome or other network parameters to an operator or other user.

The network reconstruction system 100 may include one or more sensors 120. The one or more sensors 120 may detect, determine, measure or otherwise obtain known data, such as the sensor data received from the one or more sensors 120. The one or more sensors 120 may be a electromyography (EMG), an electrocardiogram (EKG) sensor or other sensor, such as a wearable sensor, that may monitor one or more individuals in a population to obtain known data about a population or the network, such as a biological or physiological network. The one or more sensors 120 may be part of a computing device to monitor a computer network or other type of network.

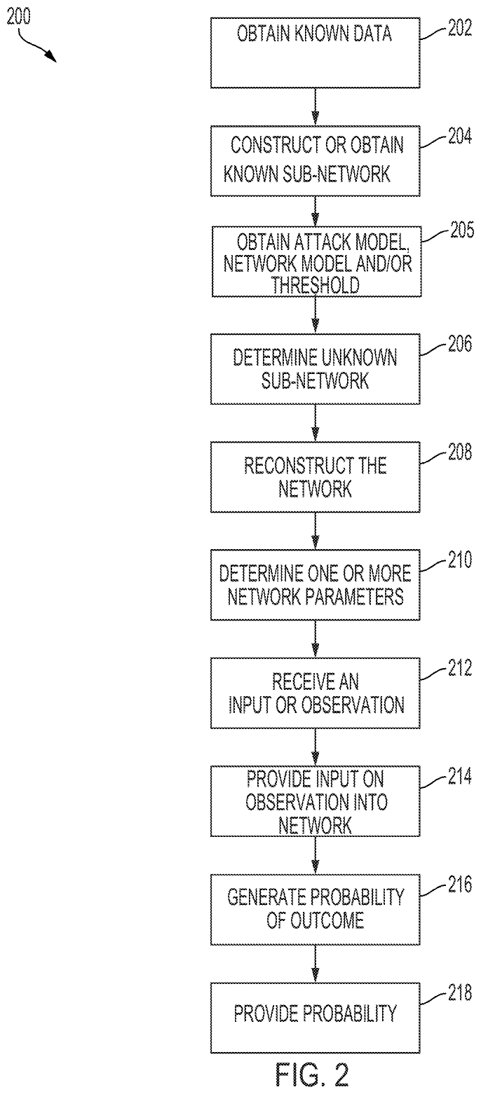

FIG. 2 is a flow diagram of an example process 200 for generating and utilizing a reconstructed network. One or more computers or one or more data processing apparatuses, for example, the processor 110 of the network reconstruction system 100 of FIG. 1, appropriately programmed, may implement the process 200.

The network reconstruction system 100 may detect, measure or otherwise obtain known data (202). The network reconstruction device 102 may use one or more sensors 120 to detect, measure or otherwise obtain the known data. In some implementations, the network reconstruction device 102 obtains the known data from the external database 104. The known data may include social data from a social network, biological or physiological data from a subject population and/or computer data from a computer network. The network reconstruction system 100 may store the known data in the memory 112 and use the known data to form a known sub-network of the network. The known data may be obtained over multiple periods of time.

The network reconstruction system 100 may construct or obtain the known sub-network of the network (204). The network reconstruction system 100 may obtain the known data from the memory 112, the one or more sensors 120 and/or the external database 104 and/or may obtain the known sub-network of the network from the memory 112 and/or the external database 104. In some implementations, the network reconstruction system 100 may determine relationships and patterns within the known data and construct the known sub-network from the known data based on the relationships and patterns. The known sub-network of the network includes known nodes and known links between and/or among the known nodes. Each node represents an event, such as output that results from one or more inputs, and each link represents a relationship between two nodes. The network may be partially observed and may be subject to attacks at an unknown time, and so, the network reconstruction system 100 may generate the remaining latent or unknown sub-network of the network and provide the node-to-time mapping because the network may obey a stochastic generative multifractal model with unknown parameters.

The network reconstruction system 100 may obtain or determine an attacker model A, an initial guess of a underlying network generative model (or “network model”), [symbol] ⁽⁰⁾, and/or a predefined tolerance threshold (205). The underlying network model may be a multi-fractal network generative model (MFNG) and be used to adapt the network reconstruction system 100 to apply to different settings. The network model may be a multi-fractal network generative model that models a variety of network types with prescribed statistical properties including a degree distribution and has unknown parameters. Given the known sub-network, Gₜ(Vₜ,Eₜ) may be subject to attacks A={A(s)} where Gₜ is the known sub-network of the network Gₒ under structural intervention. The known sub-network may obey the stochastic network generative model.

The attacker model may describe the intervention that may occur over various periods of time and the predefined tolerance threshold may be used to determine convergence. The statistical strategy of the intervention may be characterized by a power-law family of distributions,

$${A}_{α} ( {d}_{i} , t ) = \frac{{d}_{i}^{α}}{{\sum }_{i}^{N ( t )} {d}_{i}^{α}} ,$$

where A_{α}(dᵢ, s) denotes the probability of a node i of degree dᵢ to be removed from a time-varying network Gₜ=(Vₜ,Eₜ) at time t and suggests the causal dependency of interventions. N(t) is the total number of nodes at time t. α is a parameter that governs the statistical property of the adversarial intervention distribution. When α>0, the intervention prioritizes high degree nodes (hubs). Such interventions are observed in real systems obeying small-world principle. Small-world networks are known to be robust against random removals, but vulnerable to hub-prioritized attacks. For example, in biological systems, viral attackers have evolved to exploit the small-world properties and interfere in the hub proteins activity, thereby taking advantage of cellular functions for fast viral replication. In contrast, when α>0, the intervention strategy focuses on less connected nodes (i.e., boundary nodes). For instance, in computer networks, boundary nodes usually correspond to end-users with less security measures to protect their devices, thereby becoming prey to malicious hackers and malware. Random attacks are performed when α=0 and all nodes have an identical chance to be removed. The statistical strategy of the invention, at a given time s, Gₛ is a causal consequence of all intervention sequences prior to that time point. From a dynamic perspective, this time-varying distribution of the intervention leads to a time-inhomogeneous Markovian transition of Gₜ between different configurations in time. Thus, the need for a causal statistical inference framework. The attacker model, underlying network model and/or the predefined tolerance threshold may be used to determine the unknown sub-network from the known sub-network, as described below. The predefined tolerance threshold may be approximately between 10⁻³ and 10⁻² for example, so that the tolerance threshold is neither too small nor too large.

The network reconstruction system 100 may determine the unknown sub-network Mₜ of the network (206). The network reconstruction system 100 may determine the unknown sub-network based on the known sub-network, the network model, the attacker model and/or the tolerance threshold.

The unknown sub-network may include multiple unknown nodes and multiple unknown links, and the union of the unknown sub-network Mₜ and the known sub-network Gₜ form the network Gₒ, i.e., MₜU Gₜ=Gₒ. The multiple unknown links may link the multiple unknown nodes and indicate the relations between and/or among the two or more unknown nodes. The unknown nodes and the unknown links may change over multiple periods of time. The network reconstruction system 100 may determine the unknown sub-network of the network based on the known sub-network. The network reconstruction system 100 may solve or calculate the model inference and model identification simultaneously. The network reconstruction system 100 may construct a casual statistical inference framework, such as a casual inference and expectation maximization (EM) framework, to determine the unknown sub-network from the known sub-network and the node-to-time mapping. The network reconstruction system 100 may determine, predict or model the attacker's statistical behavior using a causal statistical inference framework and the network model and find the unknown sub-network and measure the node-to-time mapping π such that, [symbol] , _{Mt, π}P(Gₜ, Mₜ, π| [symbol] ,A) where [symbol] is the network model. The network reconstruction system 100 maximizes the probability and/or level of information confidence in the determined unknown sub-network given an input or new observation.

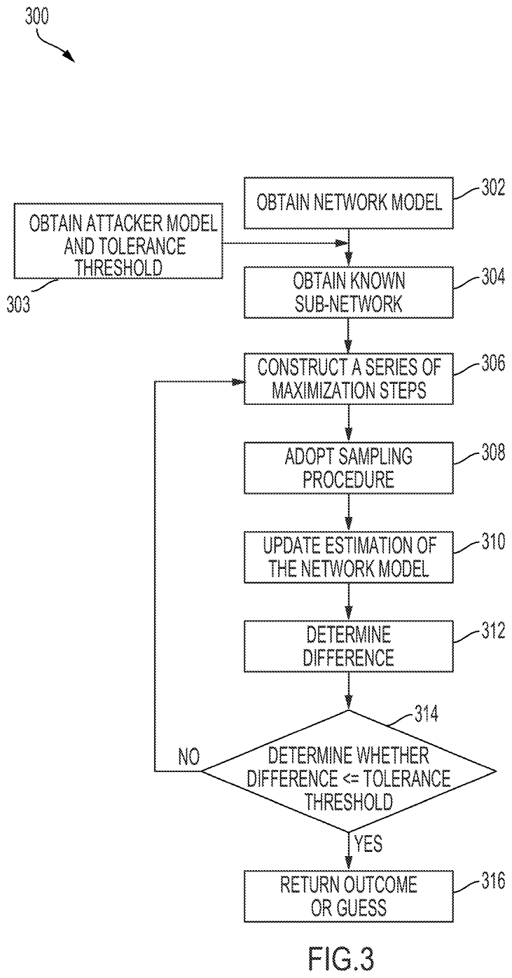

The causal statistical inference framework (or “inference framework”) jointly encodes the influence of probabilistic correlation between the known sub-network and unknown sub-network of the network and the stochastic behavior of the attacker's intervention. More importantly, this inference framework captures the temporal causality of sequenced attacks and treats the known sub-network as a result of time inhomogeneous Markovian transitions driven by the interventions. The consideration of mapping π comes from the casual interdependence on the transitional path from Gₒ to Gₜ due to the time varying interventional preference A_{α}(dᵢ, s) being a function of Gₛ. In other words, a most probable sequence of interventions needs to be discovered to maximize [symbol] , _{Mt, π}P(Gₜ, Mₜ, π| [symbol] ,A). As a result, any missing substructure in Mₜ has to be placed properly in time subject to the causality, hence the requirement of the node-to-time mapping π. FIG. 3 further describes the process 300 for reconstructing the unknown sub-network of the network.

Once the unknown sub-network of the network is determined, the network reconstruction system 100 may reconstruct the network (208). The network reconstruction system 100 may combine the known sub-network Gₜ with the unknown sub-network Mₜ to form the reconstructed network at a particular time t. The network reconstruction system 100 may determine one or more network parameters of the reconstructed network (210). The one or more network parameters may include at least one of a node-to-time mapping, a node index to linking probability index mapping, a network connectivity of the network, a probability of the network connectivity of the network, relationships between nodes of the network including any impacts one node has on another node, or constraints of the network. The node-to-time mapping may indicate the point in time that the attacker intervened at a node, and the node index to linking probability index mapping may indicate the node that was attacked or was otherwise affected and the resulting probabilistic effects on subsequent nodes within the network, e.g., the relationship among nodes in one layer to nodes in other subsequent layers within the network.

Once the one or more network parameters are obtained, the network reconstruction system 100 may receive an input or observation (212). The input or observation may indicate a node that is attacked or influenced by an attacker's intervention. The node that is attacked or influenced by the attacker's intervention may be part of the network or part of another network that has similar characteristics, such as network parameters, as the network. The network reconstruction system may receive user input that indicates the input or observation, such as from the user interface 116.

In response to the input or observation, network reconstruction system 100 may provide the input or observation into the network or other similar network having the one or more network parameters (214). The network reconstruction system 100 generates a probability of an outcome that corresponds to the input or observation into the network or the other similar network (216). And, the network reconstruction system 100 provides the probability of the outcome to an operator or user (218). The network reconstruction system 100 may output the probability of the outcome to the operator on a display, such as on the user interface 116. Moreover, the network reconstruction system 100 may provide the one or more network parameters and/or a graphical representation of the network or other network.

FIG. 3 is a flow diagram of an example process 300 for reconstructing the unknown sub-network of the network. One or more computers or one or more data processing apparatuses, for example, the processor 110 of the network reconstruction system 100 of FIG. 1, appropriately programmed, may implement the process 300.

The network reconstruction system 100 assumes, obtains or otherwise identifies and uses a network model (302). The network model induces a linking probability measure that measures or quantifies the probability of a link between an arbitrary pair of nodes i and j in the network. Given the known sub-network, Gₜ with its node arbitrarily indexed, the network reconstruction system 100 infers the correspondence between a node index i to its associated linking probability measure as in the network G₀, and thus, the network reconstruction system 100 may need to define a mapping,

$$ψ \text{:} V \to N ,$$

to be the mapping between the node index i, to its associated probability measure index i′=ψ(i). The maximization of [symbol] (Gₜ, Mₜ, π| [symbol] ,A) may be rewritten as follows:

[symbol]

,_{M(t),ψ,π}P(G^{t},M^{t},ψ,π| [symbol] ,A).

In order to infer or determine the unknown sub-network of the network, knowledge of full underlying model, [symbol] , of the network is necessary, and identifying the underlying model calls for full knowledge of the network. Thus, there is an interdependency between the knowledge of the network and identifying the underlying model. The optimal solution requires the maximization over the network model, [symbol] , and the missing information {Mₜ, ψ, π} at the same time.

The network reconstruction system 100 obtains the attacker model and/or the tolerance threshold (303). The network reconstruction system 100 obtains the attacker model and/or the tolerance threshold, as describe above. The network reconstruction system 100 uses the attacker model and/or the tolerance threshold to apply to the causal inference framework and determine convergence of the resulting sequence of the network model to a local maximizer of the likelihood function.

The network reconstruction system 100 obtains the known sub-network of the network, as described above (304). Once the network reconstruction system 100 obtains or determines the known sub-network of the network, the network reconstruction system 100 considers a maximum likelihood estimator (MLE) for the underlying model by marginalizing over the missing information to identify the network model. The network reconstruction system 100 attempts to decouple the interdependency as follows:

[symbol]

*= [symbol] P(Gₜ| [symbol] ,A)= [symbol] ∫∫∫P(Gₜ,Mₜ,ψ,π)| [symbol] ,A)dMₜdψdπ

where the likelihood P(Gₜ, Mₜ, ψ, π| [symbol] ,A) is calculated as follows:

P(Gₜ,Mₜ,ψ,π| [symbol] ,A)=(Π_{(i,j)∈E}_{₀}p_{ψ(i),ψ(j)}Π_{i′j′)∉E}_{₀}(1−p_{ψ(i′),ψ(j′)}))*yΠₛ₌₀^{t-1}A_{α}(d(π⁻¹(s)),s)

where π⁻¹(s)=Δν(s) represents the node removed at time s∈[0,t−1] and d(π⁻¹(s)) denotes its degree. The first two terms represent how likely the network structure is entailed by the underlying model. The third term encodes how much the inferred sequence of missing substructures may be explained by the statistical behavior of the attacker. The discount factor γ reflects the disagreement between the attacker's structure preference of its target and what network model suggests. If the intervention is hub-prioritized whereas the underlying network model discourages highly connected nodes, the discount factor is consequently large to emphasize the influence of the intervention. Otherwise, a small discount factor is selected. In a special case when the intervention is purely randomized (i.e., α=0), the discount factor γ is 0. This allows the formulation of the maximization of [symbol] _{Mt, π}P(Gₜ, Mₜ, π| [symbol] ,A) to be reduced to a well-researched network completion problem and leads us to the solution of the inference problem. The maximization of the probability provides an increased level of confidence that the likelihood of the formulated network is the correct network.

The network reconstruction system 100 constructs a series of maximization steps over the incomplete likelihood function in terms of the known sub-network of the network (306). Since the marginalization over the latent variable Mₜ, ψ, π are computationally intractable, the network reconstruction system 100 replaces the marginalization process by constructing a series of maximization steps over the incomplete likelihood function P(Gₜ, Mₜ, ψ, π| [symbol] ,A) conditioned on the propagated belief about the model parameters g. The network reconstruction system 100 performs multiple iterations of the maximization steps. At each iteration i-th, the network reconstruction system maximizes the log-likelihood function:

Q( [symbol] | [symbol] ₍ᵢ₎)=∫log [P(Gₜ,Mₜ,ψ,π| [symbol] ,A)]P(ψ,Mₜ,π| [symbol] ⁽ⁱ⁾,Gₜ)dMₜdψdπ.

Q( [symbol] | [symbol] ^{(t)}) constructs an incomplete maximum likelihood function in terms of the known sub-network. It averages out the contribution of the missing information {Mₜ, ψ, π} by using the incomplete MLE for [symbol] at previous step to infer a current guess on the missing information. Complex models for high dimensional data lead to intractable integrals.

In order to overcome the intractable integrals, the network reconstruction system 100 may adopt a sampling procedure (308). The network reconstruction system 100 may adopt a sampling procedure, such as a Monte-Carlo sample procedure. The network reconstruction system 100 may draw the samples from P(Mₜ, ψ, π| [symbol] ⁽ⁱ⁾, Gₜ) by varying the variables. The Monte-Carlo sample procedure may be modeled as follows:

$$Q ( \vert {( i )}^{} ) = {lim}_{k \to ∞} \frac{1}{K} {\sum }_{1}^{K} log [ P ( {G}_{t} , {M}_{t}^{( i )} , {ψ}^{( i )} , {π}^{( i )} \vert A ) ]$$

The network reconstruction system 100 may draw samples from the joint distribution P(Gₜ, Mₜ, ψ| [symbol] ,A) to perform the finite sum approximation of the expectation. Instead of using uniform sampling that generates unimportant samples in an unprincipled fashion, the network reconstruction system 100 confines the samples to be drawn from the region where the integrand of the log-likelihood function is large. Moreover, the computational intractability of sampling the posterior joint distribution also originates from the factorial dependence on the sample space on the size of the known sub-network and the unknown sub-network. This factorial dependence comes from the requirement to infer the time-stamp mapping π and the linking probability measure mapping ψ for each node in the unknown sub-network. Consider a temporally ordered sequence of subgraph Zₜ={z₀, z₁, . . . zₜ₋₁} that corresponds to trajectory of the subgraph removed at each step of the intervention up to time t. Inferring the optimal π and ψ for each node implies that when maximizing the likelihood function the following relation holds:

∀jϵV(Mₜ),∃zᵢ∈Zₜ,π(j)=V(zᵢ)∨∀i,j∈V(Mₜ),π(i)=π(j) [symbol] i=j∀jϵV(Mₜ),∃j′∈P,ψ(j)=j′

The size of the sample space is given by the number of all possible permutations of the time stamps |Mₜ|!, hence the need for factorially many samples for the finite sums approximation to be valid. One key observation is that Zₜ is also a sufficient statistic for the incomplete likelihood function Q in terms of {Mₜ, π}. In other words, there is no need to infer π and ψ separately by introducing the following mapping ψ′(π(i))=ψ(i). And so, the log likelihood function is reduced as,

$$\begin{matrix}Q ( \vert {( i )}^{} ) = \int log [ P ( {G}_{t} , {M}_{t} , ψ , π \vert , A ) ] P ( ψ , {M}_{t} , π \vert {( i )}^{} , {G}_{t} ) {dM}_{t} d ψ d π \\ = \int log [ P ( {G}_{t} , {Z}_{t} , {ψ}^{′} \vert , A ) ] P ( {ψ}^{′} , {Z}_{t} \vert {( i )}^{} , {G}_{t} ) {dZ}_{t} d ψ \\ = {lim}_{K \to ∞} \frac{1}{K} {\sum }_{1}^{K} log [ P ( {G}_{t} , {Z}_{t}^{( i )} , {ψ}^{′ ( i )} \vert , A ) ]\end{matrix}$$

Instead, an inference of the transition path Zₜ and the linking measure assignment ψ′(V(zₖ)) as in MFNG for each subgraph zₖ∈Zₜ. Alternatively stated, the nodes in the unknown sub-network are anonymized and their mapping to Zₜ is not important given the knowledge of ψ′. To efficiently estimate the joint distribution P(ψ′, Zₜ| [symbol] ^{(j)}, Gₜ, A), the network reconstruction system uses a Monte Carlo Markov Chain (MCMC) that alternates sampling from P(Zₜ|ψ′^{(τ-1)}, [symbol] ^{(j)}, Gₜ, A), and P(Zₜ|ψ′^{(τ)}, [symbol] ^{(j)}, Gₜ, A). The overall complexity of this schedule still depends on how efficiently the samples can be taken from the individual conditional distributions. The network reconstruction system 100 uses a recursive optimal substructure that is very similar to the most probably sequence problem in Markov decision process and hidden Markov model (HMM) to sample. This recursive structure draws samples from P(G_{0:t-1}|ψ′^{(τ-1)}, [symbol] ^{(j)}, Gₜ, A) efficiently via a combination of rejection sampling and Metropolis sampling.

The network reconstruction system 100 may decouple the sampling of the joint distribution P(ψ′, Zₜ| [symbol] ^{(j)}, Gₜ). The network reconstruction system 100 chooses an acceptance criteria of A(s*, s) and a proposal transition distribution q(s*|s) to satisfy the detailed balance condition,

p(s)p(s*|s)=p(s*)p(s*|s)

where p(s*|s)=A(s*, s) q(s*, s). It follows that the Markov chain {s⁽ⁱ⁾} defined by q(s*|s) has a stationary distribution of p(s). By restricting the proposal transition only from s={sⱼₖ,sₖ} to s*={s_{\k}, sₖ} for ∀k with the following acceptance probability:

$$A ( {s}^{*} , s ) = min ( 1 , \frac{p ( s * ) q ( s \vert s * )}{p ( s ) q ( s * \vert s )} )$$

where s_{\k} denotes all but the kth component. The joint distribution p(s), as the stationary distribution of this constructed Markov chain, can then be sampled by cycling through separate sampling procedures from the kth conditional distribution p(sₖ|s_{\}) for all k's. This special case of MCMC sampling provides an efficient way to decouple the sampling of Zₜ and ψ′.

To sample P(Zₜ|ψ′^{(τ-1)} [symbol] ^{(j)}, Gₜ, A), the transition equation Gₖ₊₁=G_{z}/zₖ holds for ∀zₖ∈Zₜ. Denote G_{0:t-1}={Gₜ₋₁, Gₜ₋₂ . . . G₀} as an ordered sequence of residual graph after each intervention up to time t−1 such that, G_{0:t-1}\Gₜ={Uₖ₌₁ⁱzₜ₋ₖ}_{i-1, 2, . . . , t}. Given Gₜ, this relation suggests the knowledge of Zₜ and Gₜ is interchangeable and the following probability is identical under the transformation,

$$\begin{matrix}P ( {Z}_{t} {ψ}^{′ ( τ - 1 )} , { }^{( j )} , {G}_{t} , A ) = P ( {U}_{k = 0}^{t - 1} \{ {G}_{k} + 1 ∖ {G}_{k} \} \vert {ψ}^{′ ( τ - 1 )} , {( j )}^{} , {G}_{t} , A ) \\ = P ( {G}_{0 : t - 1} \vert {{ψ}^{′}}^{( τ - 1 )} , {( j )}^{} , {G}_{t} , A )\end{matrix}$$

by Bayesian rule,

P(G_{0:t-1}|ψ′^{(r-1)}, [symbol] ^{(j)},Gₜ,A)=βP(Gₜ|G_{0:t-1},ψ′^{(r-1)}, [symbol] ₍ⱼ₎,Gₜ,A)P(G_{0:t-1},ψ′^{(r-1)}, [symbol] ₍ⱼ₎,Gₜ,A).

notice that the transition of Gₖ is driven by the attacked that depends only on the network configuration presented to it at the time of the intervention. In other words, the transition is Markovian and conditionally independent of the network model, hence we have

P(G_{0:t-1}|ψ′^{(τ1)}, [symbol] ^{(j)},Gₜ,A)

βP(Gₜ|Gₜ₋₁,A)P(Gₜ₋₁|ψ′^{(τ-)}, [symbol] ₍ⱼ₎,A){P(G_{0:t-2}|ψ′^{(τ-1)}, [symbol] ₍ⱼ₎,Gₜ₋₁,A)}

where β is the appropriate normalization factor. P(G_{0:t-1}|ψ′^{(τ-1)}, [symbol] ^{(j)}, Gₜ, A) quantifies the probability of a sequence of interventions up to time t given the underlying network and adversarial attack models. P(G_{0:t-1}|ψ′^{(τ-1)}, [symbol] ^{(j)}, Gₜ, A) represents the transition model determined by the adversarial intervention (as it is the only driver of the transition). P(G_{0:t-1}|ψ′^{(τ-}1, Gₜ, A) considers how likely Gₜ₋₁ can be explained by the underlying network model. Given Gₜ₋₁ should be supported by both the adversarial intervention model and the network model, which emphasizes again the necessity of a combined knowledge of network and adversarial intervention models. As a result, the prior methods that consider only the network models cannot be applied here.

More importantly, the third term P(G_{0:t-1}|ψ′^{(τ-1)}, [symbol] ^{(j)}, Gₜ, A) is exactly a sub-problem of the original one, hence suggesting a nice recursive structure of the inference problem, which resembles the most likely sequence problem in HMM. In principle, such recursive optimal problem structure immediately implies a dynamic programming (e.g., Viterbi algorithm) that solves the problem optimally given the initial distribution on G₀ if ψ′* and [symbol] * are known. If not, we instead take advantage of this recursive structure and draw samples from (G_{0:t-1}|ψ′^{(τ-1)}, [symbol] ^{(j)}, Gₜ, A). More precisely, for each subgraph G in time, we recursively sample Gₛ^{τ} from P(G_{0:t-1}|ψ′^{(τ-1)}, [symbol] ^{(j)}, Gₜ, A) and accept it with a probability A(Gₛ) conditioned on the previously drawn sample Gₛ₊₁^{τ},

$$A ( {G}_{s}^{( τ )} ) = \frac{f ( {G}_{s}^{( τ )} ; {G}_{s + 1}^{( τ )} )}{P ( {G}_{s}^{( τ )} \vert {{ψ}^{′}}^{( τ - 1 )} , {( j )}^{} , A )}$$

Therefore, the probability to accept Gₛ^{τ} is f(Gₛ^{τ}; Gₛ₊₁^{τ}) and the probability A(G_{0:t-1}^{τ}) to accept the entire path G_{0:t-1} is given by,

$$\begin{matrix}A ( {G}_{0 : t - 1}^{( τ )} ) = {\prod }_{s = 0}^{t - 1} f ( {G}_{S}^{( τ )} ; {G}_{s + 1}^{( τ )} ) \\ = P ( {G}_{0 : t - 1}^{( τ )} \vert {ψ}^{′ ( τ - 1 )} , {( j ) ,}^{} {G}_{t} , A ) .\end{matrix}$$

One straightforward sampling method is rejection sampling that takes samples exactly from the target distribution given a proper proposal distribution. Fortunately, such a proposal distribution can be naturally constructed by P(Gₛ|ψ′^{(τ-1)}, [symbol] ₖ^{(j)}, A) in the recursive structure of the problem and it is always locally lower bounded by f(Gₛ; Gₛ₊₁) (hence being overall lower bounded by P(G_{0:t-1}|ψ′^{(τ-1)}, [symbol] ^{(j)}, Gₜ, A)). A strict ordering holds for G_{0:t-1} such that Gᵢ⊂Gⱼ for ∀i>j. Therefore, sampling P(Gₛ|ψ′, [symbol] ₖ^{(j)}, A) requires only the sample on zₛ=Gₛ/Gₛ₊₁. The network reconstruction system 100 produces samples from P(Zₜ|ψ′^{(τ-1)}, [symbol] ₍ⱼ₎, Gₜ) whereas the acceptance rate may be practically low during the experiment as a result of unprincipled sampling from unimportant regions (low probability) of P(Gₛ|ψ′^{(τ-1)} [symbol] ^{(j)}, A). To conquer this, the network reconstruction system 100 supplements the construction of the Markov chain such that the network reconstruction system draws samples from P(Zₜ|ψ′^{(τ-1)}, [symbol] ₍ⱼ₎, Gₜ, A) once a sample Z^{(τ)} is obtained. Specifically, given Z^{(τ)}={zₜ₋₁^{(r)}, zₜ₋₂^{(r)}, . . . , z₀^{(r)}}, we define the transition probability for each zₖ^{(τ)} by,

$${P}_{{z}_{k}^{( τ )} \vert {z}_{k}^{(* )}} = \frac{1}{d ( i )} \frac{{P}_{i , x}}{{\sum }_{y} {p}_{i , y}}$$

where i∈V(zₖ^{(τ)}), x∈(zₖ^{(*)}) and γ∈V(Gₜ∪{{zₜ₋₁^{(r)}, zₜ₋₂^{(r)}, . . . , z₀^{(r)}}). For ∀k<t, the following procedure induces a Markov chain with respect to zₖ with its stationary distribution being f(Gₖ; Gₖ₊₁): (i) Randomly sample an edge (i,j) where i∈V(zₖ^{(τ)}) and j∈V(Gₜ{zₜ₋₁^{(r)}, zₜ₋₂^{(r)}, . . . , z₀^{(r)}}) with a probability P{(i, j)}=1/d(i); (ii) Randomly sample an edge (i,j) where i∈V(zₖ^{(τ)}) and j∈V(Gₜ{zₜ₋₁^{(r)}, zₜ₋₂^{(r)}, . . . , z₀^{(r)}}) with a probability P{(i, j)}=1/d(i); (iii) Randomly sample an edge (i, j) where i∈V(zₖ^{(τ)}) and j∈V(Gₜ{{zₜ₋₁^{(r)}, zₜ₋₂^{(r)}, . . . , z₀^{(r)}}) with a probability P{(i, j)}=1/d(i); (iv) Rewire (i, j) to (i, j′) to produce zₖ^{(*)} with probability, p_{i,j′}/Σ_{y}p_{i,y} where y∈V(Gₜ({zₜ₋₁^{(r)}, . . . z₀^{(r)}}); and (v) Accept zₖ^{(*)} with probability

A(zₖ^{(*)},zₖ^{(τ)}),=min(1,\tilde{p}(zₖ^{(*)})P_{z}_{ₖ}_{^{(*)}}_{|z}_{ₖ}_{^{(τ)}}/\tilde{p}(zₖ^{(τ)})P_{z}_{ₖ}_{^{(τ)}}_{|z}_{ₖ}_{^{(*)}})

where \tilde{p}(zₖ)=f (Gₖ; Gₖ₊₁). Define P_{z}_{ₖ}_{^{(τ)}}_{|z}_{ₖ}_{^{(*)}}=P_{z}_{ₖ}_{^{(τ)}}_{|z}_{ₖ}_{^{(*)}}A(zₖ^{(*)}, zₖ^{(τ)}), it can be shown that the constructed Markov chain satisfies the following detailed balance condition,

f(Gₖ^{τ};Gₖ₊₁^{τ})\tilde{P}_{z}_{ₖ}_{^{(τ)}}_{|z}_{ₖ}_{^{(*)}}=f(Gₖ^{(*)};Gₖ₊₁^{(*)})\tilde{P}_{z}_{ₖ}_{^{(τ)}}_{|z}_{ₖ}_{^{(*)}})

And so, samples are drawn from P(Zₜ|ψ′^{(τ-1)}, [symbol] ^{(j)}, Gₜ, A).

To sample P(ψ′|Zₜ^{(τ)}, [symbol] ^{(j)}, Gₜ, A), the network reconstruction system 100 may use a MCMC approach. The network reconstruction system 100 may construct a Markov chain for the sampling of mapping ψ′; by repeating the following procedure: (i) Randomly sample two indexes i and j in ψ′^{(τ)} and swap them ψ′^{(*)}; and (ii) Accept ψ′^{(*)} with probability A(ψ′^{(*)},ψ′^{(τ)}) where A(ψ′^{(*)},ψ′^{(τ)}) is defined by,

$$A ( {ψ}^{′ ( * )} ; {ψ}^{′ ( τ )} ) = min ( 1 , \frac{P ( {ψ}^{′} \vert {Z}_{t}^{(* )} , {( j )}^{} , {G}_{t} )}{P ( {ψ}^{′} \vert {Z}_{t}^{( τ )} , {( j )}^{} , {G}_{t}} ) .$$

In each iteration, the network reconstruction system 100 updates the estimator of the network model, [symbol] ⁽ⁱ⁾ (310). The network reconstruction system 100 may update the estimator of the network model by maximizing the incomplete maximum likelihood function, Q( [symbol] | [symbol] ^{(t)}) as follows:

[symbol]

⁽ⁱ⁺¹⁾= [symbol] *Q( [symbol] | [symbol] ⁽ⁱ⁾).

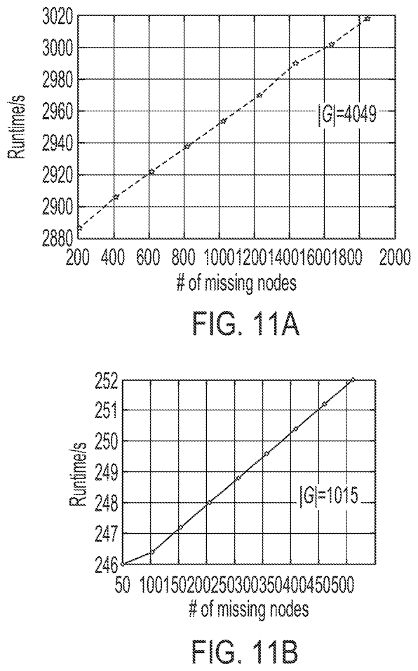

A batch gradient descent approach may be adopted to optimize the incomplete log-likelihood function Q( [symbol] ₖ^{(j+1)} [symbol] ₍ⱼ₎) at jth iteration and the overall E step may involve taking samples from the distribution P(ψ′^{(τ-1)}, Zₜ| [symbol] ₍ⱼ₎, Gₜ) which can be addressed by the proposed alternated MCMC sampling processes for both P(Zₜ|ψ′^{(τ-1)}, Gₜ, A) and P(Zₜ|ψ′^{(τ-1)}, [symbol] ^{(j)}, Gₜ, A). Since MCMC surely produces a sample after each iteration in O(1) time, the amortized sampling cost is thus O(|Zₜ|) where |Zₜ| being the size of latent network. Consider K+B samples in total, each iteration of the E step takes O((K+B)|Zₜ|). M step involves the optimization of the Q function by gradient descent. The amortized cost of the gradient calculation is given by O|E₀| per sample. Therefore, the worst-case computational complexity of one iteration of EM is O(KS|E₀|+(K+B)|Zₜ|) where S is the number of optimization steps, K is the number of samples and B is the number of burn-in samples |E₀| is a quadratic function of network size and the number of samples required to identify the network model also grows exponentially in the worst case. This is shown in FIGS. 11A-11B that runtime is dominated by the network size and slowly increases as the |Zₜ| grows where |Zₜ₁ is the number of latent nodes. Thus, O(KS|E₀|+(K+B)|Zₜ|)=O(KS|E₀|) and the computational complexity is mainly decided by the M-step.

The network reconstruction system 100 may determine a difference between the current result of an inference of the next layer of the unknown sub-network at a current step with a previous result of the layer of the unknown sub-network at a previous step (312) The network reconstruction system 100 may determine the difference as follows:

P(Gₜ| [symbol] ⁱ⁺¹,A)−P(Gₜ| [symbol] ⁱ,A).

The network reconstruction system 100 determines whether the difference is less than or equal to a tolerance threshold (314). Under regularity conditions and given a suitable starting value [symbol] ⁽⁰⁾, the resulting sequence will converge to a local maximizer of the likelihood function. The network reconstruction system 100 compares the difference to the tolerance threshold to determine whether the resulting sequence [symbol] converges to a local maximizer of the likelihood function. When the difference is greater than the tolerance threshold, the network reconstruction system 100 determines that the resulting sequence has not converged to the local maximizer of the likelihood function and reconstructs the series of maximization steps over the incomplete likelihood function in terms of the known sub-network of the network using different variables of the network model (306). When the difference is less than or equal to the tolerance threshold, the network reconstruction system 100 determines that the resulting sequence has converged to the local maximizer of the likelihood function and returns the most probable guess or outcome on Mₜ, ψ, and π in a maximum likelihood sense (316). When the resulting sequence has converged, this may indicate that the layer of nodes within the unknown sub-network that have been identified results in a maximization in the likelihood or level of confidence that the layer of nodes belongs in the network and the process may be repeated until the entire unknown sub-network is formed so that the network reconstruction system 100 may reconstruct the network.

The above procedure not only constructs a MLE for the underlying model but also simultaneously returns the most probable guess or outcome on Mₜ, ψ, and π in a maximum likelihood sense. The network reconstruction system 100 infers the unknown sub-network, node-time-mapping and node index to linking probability index mapping, {Mₜ, ψ, π}, by taking the maximum likelihood estimator of argmax_{M(t),ψ,π)}P(M(t), ψ, π| [symbol] ^{(k)}, G(t), A), and provides the {Mₜ, ψ, π} to reconstruct the network or similar network to be used to model one or more networks given a known input or observation, as described above.

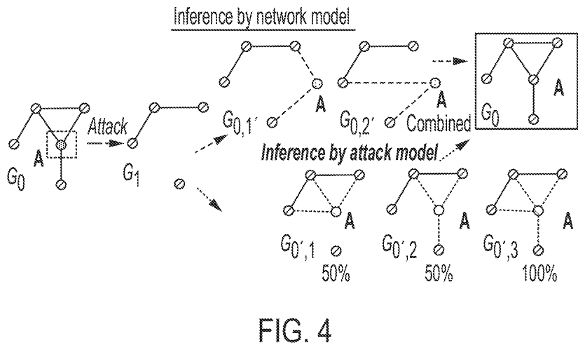

FIG. 4 shows a graphical representation of the network model and adversarial intervention behavior using the network reconstruction system 100. The network reconstruction system 100 uses an iterated inference within an EM framework and combined modeling of the network and interventional behavior to achieve success of the iterated inference. For example, a toy problem is considered in FIG. 4. An attacker removes node A from G₀. G₁ is the resulting network after the attack. The problem is to infer G₀ from G₁. 3 assumptions are made (i) The attacker always targets the most connected node. When such a node is not unique, it randomly chooses one. (ii) There is an underlying generative model for G₀ that discourages nodes of high connectivity and does not allow for disconnected nodes. (iii) There is perfect knowledge of both the attacker and the generative model.

According to the Bayesian inference principle, the missing nodes and its links that maximize the likelihood based on the network model and the attacker's statistical behavior may be inferred. By assumption (ii), the missing node may be inferred based on the network model will be less likely to have a higher degree. G_{0,1′} therefore can be one of the possible outcomes (G_{0,2′} represents another possibility). Although G_{0,1′} is not unique, one must choose it over many other possible configurations where node A has a higher degree. By assumption (i), the missing network inferred based on the attack can be G_{0,1′}, G_{0,2′}, or G_{0,3′} (other outcomes removed due to symmetry). However, node A is not unique most connected node in G_{0,1′}, G_{0,2′} (i.e., only 50% chance to be chosen). Therefore, G_{0,3′} is the most probable outcome. Interestingly, neither G_{0,3′} is the most probably outcome. Interestingly, neither G_{0,1′} nor G_{0,3′} represents the true configuration. From the perspective of the network model, G_{0,3′} is less likely structure due to the highly connected node. G_{0,1′} is less likely (⅓ chance) to be the target of the attacker. Combining the knowledge of both leads us to the true G₀ in this simple case. Thus, the attack model and formulate the challenge as causal inference problem of time-varying complex networks under adversarial interventions as follows.

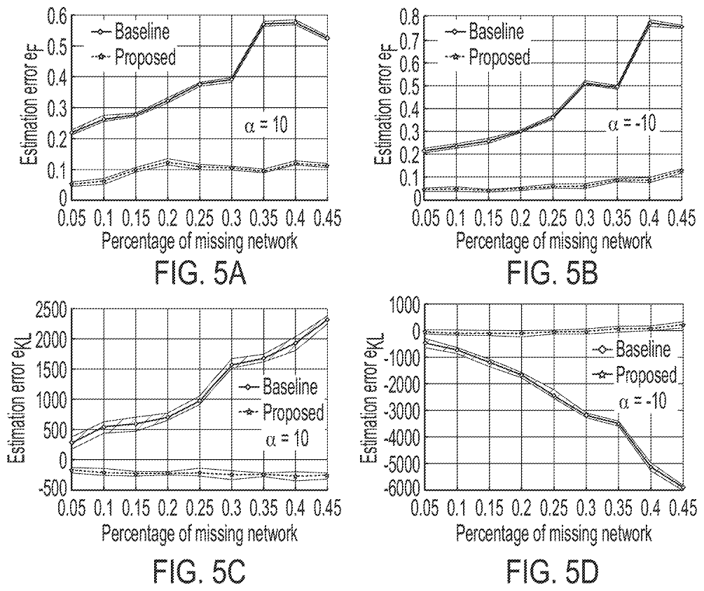

The inference framework may retrieve the original network if there is perfect knowledge about the network model that generates it. In a test network G₀ of 1024 nodes (k=10, m=2) with a randomized generating measure P. Then the intervention A_{α}(dᵢ, t) is introduced sequentially for T steps, where T ranges from 5% to 45% of the total number of nodes in the original network. The statistical preference of the intervention may be varied using the setting α differently to be 10 (hub-prioritized attack) and −10 (boundary-node prioritized attack). These values correspond to two distinct attack strategies that also influence the network inference process. Each intervention process is repeated for 10 times for every combination pair of (T, α). The estimated generating measure induced by [symbol] as \hat{P} and true one as P*. The first estimation error may be reported as the Frobenius norm e_{F} of their difference to quantify the capability to recover the generating measure P. FIGS. 5A-5D show the results averaged over 10 intervention trials as a function of amount of missing information. In contrast to the baseline, the estimation error of the proposed method is robust against the loss of network structural information and delivers accurate estimation of the underlying parameters even when 45% of the network is structurally sabotaged by the intervention. More importantly, the estimation error for the baseline is significantly larger than the proposed approach even for small percentage of network information loss (5-10%).

These results demonstrate the importance of accounting for the effect of intervention on the network probability measure. EM-type inference methods essentially construct the maximum likelihood estimator based on iteratively optimized incomplete likelihood function (i.e., Q-function). Instead of solving analytically this Q-function, Monte Carlo method highly relies on being able to draw samples of the latent variables (e.g., the missing network) from a distribution that is increasingly approaching their true distribution. As a result, the estimator converges to local maxima in the statistical manifold (as the generating measure P uniquely defines a distribution on a unit square). However, if the samples of the latent variables are always drawn from a distribution that is significantly different from the true distribution, it is unlikely that the estimates will be close to the true parameters and the resulting deviation increases with higher dimension of latent space (e.g., number of missing nodes increases).

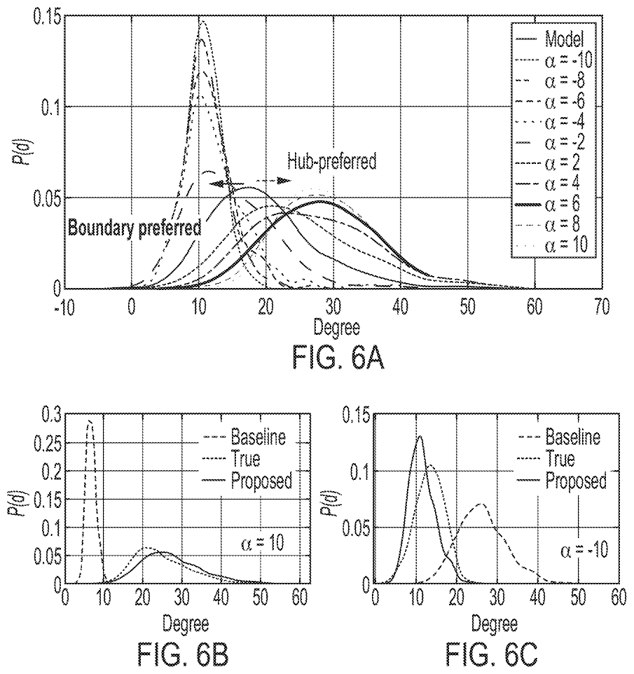

Unfortunately, this is exactly how the baseline fails. The network model and the interventions now jointly determine the distribution of the missing network. For instance, the degree distribution of victim nodes under a hub-prioritized intervention must concentrate the probability mass to the regions of relatively high degree (right-shifted in relation to what network model suggests). Failure to draw samples of the latent variable from their true distribution, we visualize the degree distribution of missing nodes and that supported by the true underlying model in FIG. 6A via kernel smoothing method. 40% of nodes and their links were removed with a ranging from −10 to 10. As predicted, the degree distribution of missing network concentrates increasingly its mass to the region of high degree as a becomes positively larger. Similar observation is due when a becomes negatively smaller. In either case, they are significantly shifted from the degree distribution supported by the network model which explains the large estimation error of the baseline. More precisely, FIGS. 5C-5D report the Kullback-Leibler (KL) divergence era as a function of α and amount of lost information. FIG. 5C shows that the baseline always underestimates (i.e., positive KL divergence) the linking probability of the missing nodes when α=10 and overestimates (i.e., negative KL divergence) it in FIG. 5D when α=−10. This shows that the baseline neglects the intervention influence and suffers from large estimation errors.

To better illustrate this, FIG. 6B-6C shows two degree distributions of the missing network recovered by the baseline and proposed methods. FIG. 6B shows that the degree of distribution retrieved by the baseline shifts greatly to the left of the true one (underestimation) when α=10 and the situation is reversed (overestimation) when α=−10. In contrast, the network reconstruction system 100 recovers the distribution well in both cases. The network reconstruction system 100 incorporates the influence of the attack on the inference and takes only samples (as in the Monte Carlo process) approved by both the model and the attacker. Consequently, it is robust against the loss of information and delivers accurate estimations.

In the first set of experiments with real networks, the framework may recover latent gene interaction and brain networks when exposed to simulated targeted attacks. Attackers like virus or cancer cells in these systems usually do not possess the knowledge of the full network. However, the rationale for considering targeted attacks on these systems is that, when global information is not available, the probability of reaching a particular vertex by following a randomly chosen edge in a graph is proportional to the vertex's degree. This makes the degree centrality an important factor in quantifying the vulnerability of the nodes, even if the attacker has only extremely localized information (e.g., connectivity). This resonates well with some our biological findings in terms of viral spreading and protein inhibition.

A targeted attack progress in two biological networks (hu.MAP and human brain connectome) with α=1 that models the hub-preferential interventions observed in real systems. The hu.MAP network encodes the interactions of human protein complexes. The huMAP network is a synthesis of over 9000 published mass spectrometry experiments containing more than 4600 protein complexes and their interactions. Of all protein complexes, the largest connected component consisting of 4035 protein complexes and used it as the target network. The Budapest Reference Connectome v3.0 generates the common edges of the connectomes of 1015 vertices. It is computed from the MRI of the 477 subjects of the Human Connectome Project 500-subject release. The percentage of the missing network nodes may be varied from 5% to 45% under a simulated attack that removes nodes. Both ROC-AUC and PR-AUC scores are computed under varying range thresholds to quantify the inference capability of the models retrieved by baseline and the framework.

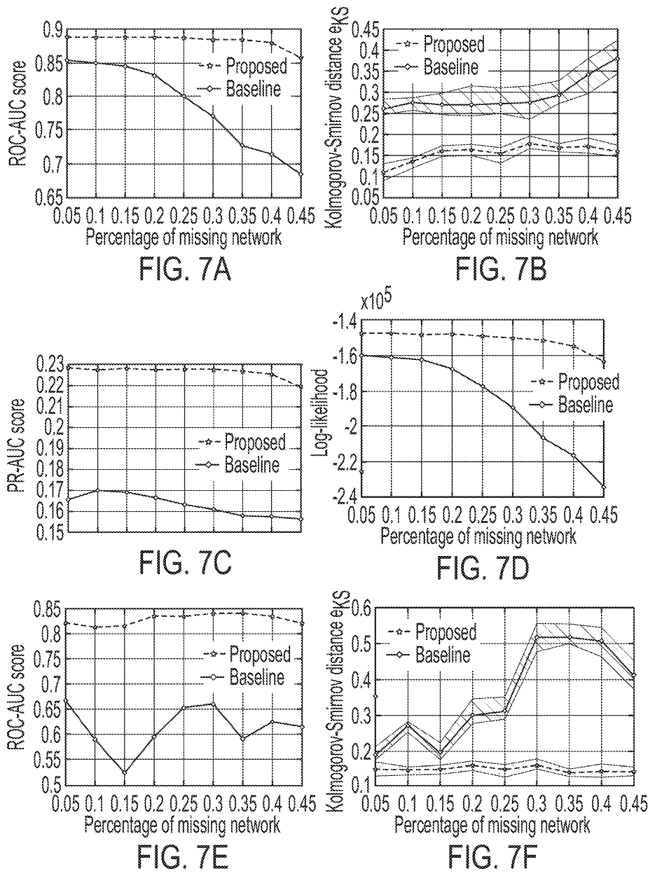

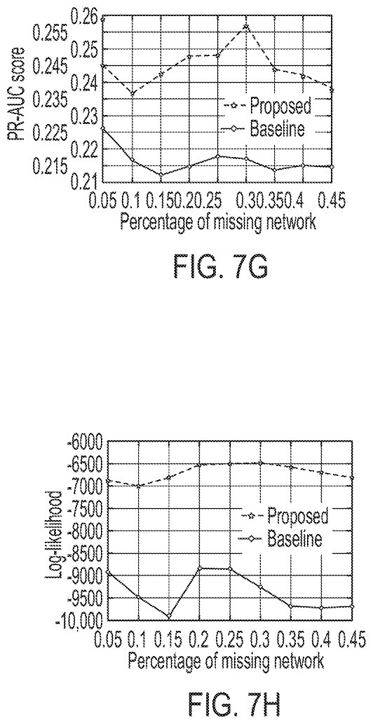

For hu.MAP network, FIG. 7A shows that the ROC-AUC score stays around 0.88 with only a small decrease to 0.85 when 45% of the nodes are removed. In contrast, the ROC-AUC score of the model retrieved by the baseline degrades sharply from 0.85 to 0.68. Similar observations are due for the PR-AUC score where proposed framework raises it from 0.17 to 0.23 with 5% of node loss and from 0.15 to 0.21 when 45% of nodes are removed. The PR-AUC score is much lower as compared to ROC-AUC due to the sparsity of the network. The number of links (i.e., positives) is much smaller than that of a complete network of the same size and both methods produce noticeable amount of false positives. The source of these false positives can be (i) insufficient order of the model (e.g., choose larger k for linking measure matrix), (ii) insufficient sample size in E-step, (iii) overshooting in M-step. While realizing the space for fine-tuning and improvement, the framework places no constraint on the proper choice of model and its real power lies in considering and exploiting the influence of interventions, rather than treating them as a random sampling process.

For human brain connectome, a slightly different pattern emergences in FIG. 7E. While ROC-AUC score obtained by the framework is consistently higher than the baseline, the score of both degrades first (up to 15% of nodes removed) and then oscillates afterwards. This phenomenon is due to three facts: (i) human brain connectome is rich in small-worldness; (ii) there are much fewer hubs in brain connectome than in hu.MAP; (iii) the intervention becomes close to a random sampling after most of the hubs are removed and small-world networks are robust against such random removals. As a result, the attack process quickly reduces to a random sampling after the few hubs are removed. Thereafter, the residual network loses the structural resemblance to the original network, which serves as the very basis for EM-type inference frameworks to work. Averaging out the contribution of latent structure in the E-step now effectively wipes out the structural properties of the original network to be recovered (as it becomes dominant now). This leads the iterative optimization process of EM to a nondeterministic search in the solution space (which is super-exponentially large), leading to predictions that are not aligned with the original networks. However, even under conditions, our framework consistently recovers the network that is more structurally similar to the original one. Thus, exploiting the combined knowledge of the generative model and the intervention may significantly boost the performance.

In order to quantify the capability to recover the global property or the one or more network parameters of the original network, one may use the log-likelihood and KS distance. The KS distance may be averaged over 1000 network samples drawn from both models and shown in FIGS. 7B and 7F, respectively. The lines in FIGS. 7B and 7F represent the averaged distance with the shades being the standard deviation. In both figures, the KS distance of the generated network via the framework is consistently robust to the interventions and more accurately retrieved than the one obtained by the baseline approach, which is an indicator of a boosted structural similarity between the true one and the synthesized ones. The log-likelihood function is computed in FIGS. 7D and 7H, respectively, based on both models with respect to the original network.

FIGS. 7D and 7H are similar to each other, suggesting that the overall goodness-of-fit of the identified model highly relies on being able to guide the optimization in EM framework iteratively towards a linking probability (i.e., a network model) that best explains the original network. Otherwise, the error can easily propagate repetitively between the inference and the estimation step, resulting in a retrieved model that poorly explains the original network as we have seen in these two figures. Both perform similarly to fit a model that explains the observed part of the network. However, the baseline retrieves models incapable of inferring the latent structure as accurately (quantified by the AUC scores) as the inference framework used by the network reconstruction system 100 does. Consequently, the difference of log-likelihood in terms of the latent structure dominates, hence producing a similar pattern between AUC score curve and log-likelihood curve.

A significant boost in structural similarity using the framework that incorporates and exploits the influence of the interventions on the underlying distribution of the latent structures of the two studied biological networks as compared to the baseline that treats the unobserved and observed networks in a statistically equal way (i.e., random sampling assumption). The framework may then be used to discover the unknown sub-network in a simulated removal process that mimics the social network interventions in an abstracted setting.

For example, the framework may be used to assist in identifying social network user privacy and information breaches via injected malicious agents (trolls and bots). These injected agents act as information collectors or launch campaigns to propagate designed information to target social groups. Together with the user nodes, the form an extended network that is usually not fully unveiled. The ultimate challenge is to estimate their structural formation and influence on various social events. Although real social network attacks can be much more sophisticated by involving multiple parties at the same time (as opposed to a coordinated sequence of operations, evolving in a statistically inconsistent way (as opposed to a stabilized and consistent stochastic behavior) and exhibiting a complex opinion diffusion dynamics. An idealized abstraction of a class of real attacks that prioritize the degree centrality. The considered attack model and its variants have been widely adopted as an abstraction of the targeted attacks for the study of robustness, stability, resilience, and defensive/attack strategies of networks ranging from mathematically constructed complex network to traffic network, brain network, computer network, and also social networks.

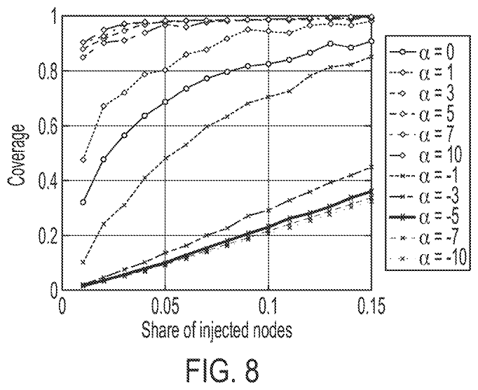

In an extended social network with 4049 nodes (including hidden nodes injected for information manipulation, referred as injected nodes, and ordinary user nodes) built from a network dataset, due to the small-worldness of the social network, only a small group of injected nodes is required to make sure all user nodes have at least one injected node as their immediate neighbor (i.e., all users are subject to data security issues and/or manipulated information even without information propagation among them). The coverage may be defined by a chance of a user node to have an immediate neighboring injected node. FIG. 8 visualizes the coverage of injected nodes against their share in the network under different a from −10 to 10. In FIG. 8, α has a different meaning and A_{α}(dᵢ) now is a proxy of the likelihood of an injected node of degree dᵢ being the highest connected node in the network. For higher α, a larger portion of the highest connected nodes are represented by injected nodes and so they have a bigger coverage. FIG. 8 suggests that 48.6% of the population have at least one neighboring injected node when the injected nodes account for only 1% of total nodes with α=1. The coverage goes up to 98.44% when injected nodes account for 15% of the network as shown in FIG. 8. This suggests that a full-scale information manipulation/collection requires only a small injection of designed agents (i.e., disseminators/collectors) into the network and these agents do not have to be significantly more connected than an average node.

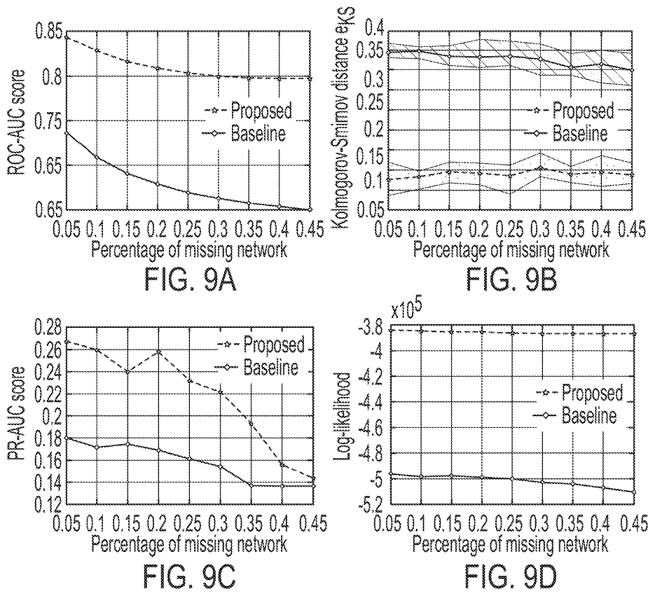

The removal process may be simulated by setting α=1 and varying the share of injected nodes from 5% to 45%. ROC-AUC and PR-AUC may be used as metrics for quantifying the inference capability and are shown in FIGS. 9A and 9C for baseline and the inference framework. Similar to the above, the ROC-AUC and PR-AUC scores of the inference framework are significantly better than the baseline, suggesting a boost in capability to infer the missing network more accurately. To measure the structural similarity, the Kolmosgorov-Smirnov (KS) distance eₖₛ between the empirical degree distribution of the original network F*(x) and networks generated by both methods F(x). The results are averaged over 1000 network instances and reported in FIG. 9C. In addition, the log-likelihood (LL) in FIG. 9D as a global metric for goodness-of-fit to compare the model identified by both the baseline and the inference framework. Although the absolute value of LL strongly varies as a function of a particular model choice for the network, the relative difference given the fixed model provides a good performance comparison between the different techniques. As expected, FIGS. 9B and 9D suggest that the inference framework retrieves a model that is more globally consistent with the true one with smaller eₖₛ and larger LL values compared to the baseline.

The statistics of both the intervention process and the complex network structure play a crucial role in these observations. First, in small-world networks, the hubs account for a small fraction of the network. Lower degree nodes are unaffected by hub-prioritized interventions. The baseline ignores the influence of the intervention and therefore is biased by the observed part towards the retrieval of a model that explains better a network without the hubs. The baseline has poor performance on inferring the missing network. Due to the time-varying nature of the interventions, the hub-prioritized interventions induce a random sampling behavior after the removal of hubs. This behavior change may be demonstrated by the small variance of the degree distribution, reshaped by the conducted intervention. Consequently, the performance of the baseline and inference framework exhibit a plateau since a small-world network is robust against random removals.

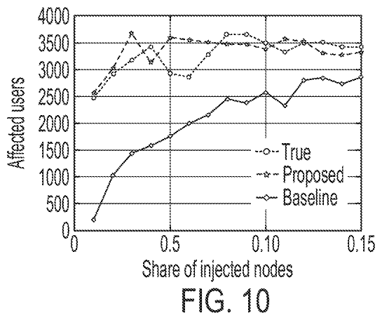

The estimated number of user nodes (or “affected users”) with at least one injected node as their immediate neighbor. Without considering the opinion diffusion dynamics, this measurement serves as an upper bound on the number of users being exposed to designed information or personal data breaches. To consider a more realistic setting, this assessment should also incorporate the propagation of information among users, which is left as an important extension in our future work. Varying the share of injected nodes in the extended social network from 1% to 15%, FIG. 10 shows the average affected users estimated over 5000 network instances drawn from the models retrieved through the baseline and the inference network. As expected, the baseline underestimates affected users as it does not exploit the knowledge of the targeted removal process. More interestingly, when compared to FIG. 8, the curve corresponding to the estimated affected users by the baseline is almost identical to the coverage curve obtained under a random intervention (i.e., the degree of an injected node being statistically the same as a randomly chosen node in the original network without injected nodes). This suggests that the baseline works only if the intervention is purely randomized and easily fails when this assumption does not hold.

Accordingly, the causal inference framework gives a significant improvement upon the structural fidelity of inferred latent networks as a result of properly exploiting the causal influence of targeted interventions in both synthetic and realistic settings.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A network reconstruction system, comprising:
a processor configured to:
determine an unknown sub-network of a network including a plurality of unknown nodes and a plurality of unknown links based on a known sub-network of the network having a plurality of known nodes and a plurality of known links, a network model and an attacker's statistical behavior to reconstruct the network;
determine one or more network parameters of the network; and
provide a probability of an outcome of an input or observation into the network or into a second network that has the one or more network parameters of the network.

2. The network reconstruction system of claim 1, wherein the processor is configured to:
determine, predict or model the attacker's statistical behavior using a causal statistical inference framework, wherein the network model is a multi-fractal network generative model that models a variety of network types with prescribed statistical properties including a degree distribution and has unknown parameters.

3. The network reconstruction system of claim 1, further comprising:
one or more sensors configured to obtain or detect known data; or
an external database configured to store and provide the known data;
wherein the processor is configured to:
obtain, from the one or more sensors or the external database, the known data, and
construct the known sub-network of the network including the plurality of known nodes and the plurality of known links based on the known data.

4. The network reconstruction system of claim 3, wherein the known data that is obtained to form the known sub-network of the network is obtained over a plurality of different periods of time and the unknown sub-network of the network changes over the plurality of different periods of time.

5. The network reconstruction system of claim 1, wherein the network is related to a social network, a biological or physiological network or a computer network, wherein the plurality of known nodes represent events within the social network, the biological or physiological network or the computer network and the plurality of known links represent a relationship among the events within the social network, the biological or physiological network or the computer network.

6. The network reconstruction system of claim 1, wherein the one or more network parameters include at least one of a network connectivity of the network, a probability of the network connectivity of the network, relationships between nodes of the network including any impacts one node has on another node, or constraints of the network.

7. The network reconstruction system of claim 1, further comprising:
a memory configured to store known data or the known sub-network of the network having the plurality of known nodes and the plurality of known links; and
a display configured to output the probability of the outcome;
wherein the processor is coupled to the memory and the display and configured to:
obtain, from the memory, the known data or the known sub-network of the network, and
render on the display the probability of the outcome.

8. The network reconstruction system of claim 1, wherein to determine the unknown sub-network of the network the processor is configured to:
determine a causal inference of the unknown sub-network using the network model that captures properties of the network.

9. The network reconstruction system of claim 8, wherein to determine the causal inference of the unknown sub-network using the network model the processor is configured to:
construct a series of maximization steps over an incomplete likelihood function based on the network model and one or more parameters; and
iteratively maximize a log-likelihood function at each step within the series of maximization steps using a Monte-Carlo sampling procedure where the one or more parameters change until a current result of the log-likelihood function at a current step converges with a previous result of the log-likelihood function at a previous step.

10. The network reconstruction system of claim 9, wherein to determine the causal inference of the unknown sub-network using the network model the processor is configured to compare a difference between the current result and the previous result with a tolerance, wherein the current result converges with the previous result when the difference is less than or equal to the tolerance.

11. A method for network reconstruction, comprising:
determining, by a processor, an unknown sub-network of a network including a plurality of unknown nodes and a plurality of unknown links based on a known sub-network of the network having a plurality of known nodes and a plurality of known links, a network model and an attacker's statistical behavior to reconstruct the network;
determining, by the processor, one or more network parameters of the network; and
providing, by the processor, a probability of an outcome of an input into the network or into a second network that has the one or more network parameters of the network.

12. The method of claim 11, comprising:
storing, in a memory, known data or the known sub-network of the network having the plurality of known nodes and the plurality of known links;
obtaining the known data or the known sub-network of the network; and
rendering on the display the probability of the outcome.

13. The method of claim 11, wherein the one or more network parameters include at least one of a network connectivity of the network, a probability of the network connectivity of the network, relationships between nodes of the network including any impacts one node has on another node, or constraints of the network.

14. The method of claim 11, further comprising:
determining the attacker's statistical behavior using a causal statistical inference framework, wherein the network model is a multi-fractal network generative model that models a variety of network types with prescribed statistical properties including a degree distribution and has unknown parameters.

15. The method of claim 11, wherein determining the unknown sub-network of the network includes:
determining a causal inference of the unknown sub-network using the network model that captures properties of the network.

16. The method of claim 15, wherein determining the causal inference of the unknown sub-network using the network model includes:
constructing a series of maximization steps over an incomplete likelihood function based on the network model and one or more parameters; and
iteratively maximizing a log-likelihood function at each step within the series of maximization steps using a Monte-Carlo sampling procedure where the one or more parameters change until a current result of the log-likelihood function at a current step converges with a previous result of the log-likelihood function at a previous step.

17. The method of claim 16, wherein determining the causal inference of the unknown sub-network using the network model includes comparing a difference between the current result and the previous result with a tolerance, wherein the current result converges with the previous result when the difference is less than or equal to the tolerance.

18. A non-transitory computer-readable medium comprising computer readable instructions, which when executed by a processor, cause the processor to perform operations comprising:
determining an unknown sub-network of a network including a plurality of unknown nodes and a plurality of unknown links based on a known sub-network of the network having a plurality of known nodes and a plurality of known links, a network model and an attacker's statistical behavior to reconstruct the network;
determining one or more network parameters of the network; and
displaying a probability of an outcome of an input into the network or into a second network that has the one or more network parameters of the network.

19. The non-transitory computer-readable medium of claim 19, wherein the operations further comprise:
determining the attacker's statistical behavior using a causal statistical inference framework.

20. The non-transitory computer-readable medium of claim 19, wherein the network model is a multi-fractal network generative model that models a variety of network types with prescribed statistical properties including a degree distribution and has unknown parameters.
